(19) United States
(12) Patent Application Publication
(10) Pub. No.: US 2022/0054363 A1
(43) Pub. Date: Feb. 24, 2022

(54) Magnetic Pacifier with Tracking Device

(71) Applicant: Merri Laursen, Sitka, AK (US)

(72) Inventor: Merri Laursen, Sitka, AK (US)

(21) Appl. No.: 17/203,895

(22) Filed: Mar. 17, 2021

Related U.S. Application Data
(60) Provisional application No. 63/067,426, filed on Aug. 19, 2020.

(51) Int. Cl. A61J 17/00; H01F 1/057

(52) U.S. Cl. CPC A61J 17/001; H01F 1/057; A61J 17/113; A61J 17/111

(57) ABSTRACT

This present invention relates to a magnetic pacifier that is capable of being used with a face mask or other facial covering, and that does not negatively impact the effectiveness of the facial covering. The magnetic pacifier is of two part construction, wherein a first flange is positioned on one side of the facial covering, and a second flange is positioned on the opposite side of the facial covering but magnetically attached to the first flange. The magnetic pacifier further comprises a discreet but effective RFID tag, GPS chip or other location beacon that will allow the parent, guardian, caregiver or law enforcement to located a missing child via the pacifier.

### CROSS-REFERENCE TO RELATED APPLICATION

The present application claims priority to, and the benefit of, U.S. Provisional Application No. 63/067,426, which was filed on Aug. 19, 2020 and is incorporated herein by reference in its entirety.

### FIELD OF THE INVENTION

The present invention relates generally to the field of baby products. More specifically, the present invention relates to a magnetic pacifier capable of being utilized over a protective face mask worn by an infant. The uniquely designed magnetic pacifier maintains the safety of the infant by permitting the infant to both wear a facial mask and utilize the pacifier at the same time. The unique structure of the magnetic pacifier also enables the pacifier to be attached to a backpack or item of clothing when not in use to keep it clean and prevent it from being dropped, and has an incorporated tracking mechanism that makes it easy to locate the pacifier if misplaced. The magnetic pacifier offers a way to keep an infant both calm and entertained, while also reducing the chances of the infant inhaling germs, viruses, bacteria and other airborne pathogens through the wearing of a face mask or other facial covering. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, pacifiers are typically used by infants and young children to help soothe and calm the infant or child. More specifically, parents may utilize an infant pacifier to help their child get through periods of crying when the infant is either not hungry, too full to eat, teething or is otherwise uncomfortable, and needs the comfort that sucking on a pacifier provides. Further, pacifiers are known to protect an infant baby from sudden infant death syndrome (SIDS) and suffocation during sleep due to the regular sucking action induced by the pacifier. Additionally, pacifiers have been widely used for the purposes of distracting an infant or young child during general unease, fussiness, or when the child is sick, goes for a check-up, while traveling, or in other similar situations where there may be some stress or discomfort of the child.

In times of a pandemic, it is important and advisable that all individuals, including infants and young children wear a protective face mask when outside of the home or when the individual comes into contact with other individuals. Protective face masks cover the nasal and oral passageways of the individual, thereby creating a barrier against the transmission of harmful pathogens, germs, bacteria or the like through said passageways. In this way, face masks help to prevent the spread of infectious diseases, germs, bacteria, harmful microbes and the like by protecting a non-infected wearer from potential exposure, and an infected wearer from further transmitting the same.

Unfortunately, many infants, toddlers and young children can become incredibly uncomfortable and unsettled while wearing a protective face mask. Accordingly, many infants and other young children are usually reluctant to wear a face mask and may cry or try to remove the face mask. However, not wearing a face mask in public, particularly during the time of a pandemic, may spread the infectious disease(s) and/or leave the infant, as well as his or her family members, at risk of being exposed to harmful pathogens, and may cause the infant to become infected and suffer from infectious diseases.

Additionally, most face masks available in the market today for infants cover the oral and nasal passageways completely to provide protection against the spread of diseases, and do not allow a pacifier to be used while properly using the mask. Therefore, in order to properly use a pacifier for an infant, the parents or other caregivers are required to remove the face mask from the infant, and then allow the infant to use the pacifier. However, in such situations, when the mask is removed, the infant is at risk of contracting an infectious disease. Furthermore, attempting to utilize a pacifier under a face mask typically causes a significant amount of separation of the face mask from the face of the infant or young child, which allows breathable air to bypass the face mask and significantly limit its effectiveness.

Furthermore, infants and small children will oftentimes spit out, drop or throw their pacifier, which could result in the same becoming dirty, contaminated or even lost. Once the pacifier becomes dirty or contaminated, it must be properly cleaned before it can be returned to productive use. Unfortunately, this could result in the infant or young child going without his or her pacifier and becoming irritated. Additionally, if the pacifier becomes lost, the infant or young child may have to go even longer without the pacifier until their parents, guardian or caregiver can replace the same.

Therefore, there exists a long felt need in the art for a pacifier device for an infant or small child that allows the infant/child to utilize the pacifier while the infant/child is wearing a face mask. There is also a long felt need in the art for a pacifier device which soothes and calms the infant/child without compromising the effectiveness of the face mask. More specifically, there is a long felt need in the art for a pacifier device which allows the face mask to be properly secured against the infant/child's face while the infant is using the pacifier, and that can easily be used with different types of protective face masks. Additionally, there is a long felt need in the art for a pacifier device that can be clipped to the infant/child's clothing to prevent the same from becoming dirty or contaminated, and that comprises a tracking device that allows the pacifier and the infant that it is attached to be quickly located. Finally, there is a long felt need in the art for a pacifier device that is relatively inexpensive to manufacture and that is both safe and easy to use.

The subject matter disclosed and claimed herein, in one embodiment thereof, comprises a novel magnetic pacifier that can be used in conjunction with a face mask, and that does not interfere with the effectiveness of the face mask. The improved pacifier device is comprised of two flanges, wherein both flanges have two opposite surfaces. The first flange has an embedded handle on its first surface, and a first magnetic ring on its second surface. The second flange has an attached nipple on its first surface, and a second magnetic ring on its second surface. The polarity of the first magnetic ring is opposite of the polarity of the second magnetic ring so that both the first and second flanges can be removably attached to one another. Further, the strength of the magnetic bond between the first and second flanges is such that the flanges are secured together even if separated by the presence of a cloth face mask, which may be positioned therebetween. Further, the magnetic pacifier of the present invention may be tethered to the infant/child's clothes so that the handle portion positioned along the other surface of the face mask will not become dirty if dropped or thrown. Finally, the magnetic pacifier may further comprise an RFID tag, GPS chip or any other similar location-tracking device for tracking and locating the pacifier, thus, assisting in locating the child in case of a kidnapping or when the child is lost.

In this manner, the novel magnetic pacifier of the present invention accomplishes all of the forgoing objectives, and provides a relatively safe, convenient and comfortable solution to permitting an infant or small child to use a pacifier while wearing a protective face mask. The magnetic pacifier of the present invention is also both infant and parent friendly, as the pacifier calms and soothes the infant while wearing the face mask and gives the parent or other caregiver piece of mind by the presence of a non-obvious infant-tracking device.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a novel magnetic pacifier that can be utilized in conjunction with a face mask and that does not interfere with the effectiveness of the face mask. The magnetic pacifier is comprised of two magnetic flanges, wherein each of the two flanges have two opposite surfaces. The first flange has an embedded handle on its first surface for handling of the pacifier and a first magnetic ring on a second surface, wherein the first flange is meant to be positioned on the outer surface of the face mask (i.e., the side of the face mask opposite the wearer's face). The second flange has an attached nipple on its first surface and a second magnetic ring on its second surface, wherein the second flange is meant to be positioned on the inner surface of the face mask (i.e., between the face mask and the wearer's face). The polarity of the first magnetic ring is opposite that of the second magnetic ring and of sufficient strength that the first and second flanges are removably and magnetically secured to one another despite the presence of a face mask between the first and second magnetic rings. The magnetic pacifier further comprises a tethering mechanism for attaching the handle of the first flange to the infant's clothes, and an RFID tag, GPS chip or any other similar location-tracking device for tracking and locating the pacifier, thus assisting in locating the child in case of a kidnapping or if the child is lost.

In a further embodiment of the present invention, an infant pacifier is disclosed and comprises a nipple, a flange with two magnetic pieces and a handle. The first magnetic piece is attached to the nipple, and the second magnetic piece is attached to the handle. The two magnetic pieces are removably attached to each other on opposite sides of a face mask being worn by the infant or small child utilizing the pacifier, so as to not interfere with the effectiveness of the face mask. The pacifier is further comprised of an implanted transmitter or beacon chip that sends a Bluetooth signal to a paired smartphone belonging to a parent or other authorized caretaker so that the parent/caretaker can continuously monitor and track the location of the child who is using the pacifier. The beacon may be activated when both of the magnetic pieces are attached together via the magnetic fastener to conserve battery power.

In a further embodiment of the present invention, a magnetic pacifier that is capable of being connected and used in connection with a personal protective face mask or other filtering mechanism is disclosed. The pacifier has two round or flange-shaped magnetic pieces, namely a first magnetic piece and a second magnetic piece. Each magnetic piece has a magnetic surface and a non-magnetic surface. The first magnetic piece has magnets in the form of a continuous ring or alternatively discrete magnets disposed on the surface in a particular pattern and a silicone pacifier positioned on the opposite or non-magnetic surface. The second magnetic piece has magnets of opposite polarity of the magnets of the first magnetic piece on its magnetic surface, and a gripping ring on its non-magnetic surface such that the two magnetic pieces may be attached to one another from opposite sides of a face mask, air filter, clothing or similar face coverings.

In yet another embodiment of the present invention, a method of using a two piece pacifier along with a face mask that permits a child to maintain comfort when sucking on a pacifier while also wearing a face mask is disclosed. The method comprises the steps of initially placing a silicon pacifier connected to a first magnetic piece inside the child's mouth. Next, covering the child's mouth with a cloth or paper face mask positioned over the first magnetic piece in an effort to protect the child from infectious diseases, germs, pathogens and the like. A second magnetic piece is then placed over the face mask on the opposite side of the first magnetic piece to attach to the first magnetic piece by magnetic forces present on both the magnetic pieces to complete the pacifier device. Finally, the location of the pacifier device (and therefore the child) is monitored through an RFID tag, GPS chip or any other similar location tracking device that is paired to an electronic device, such as a smartphone, smart watch, tablet, computer or the like.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a magnetic pacifier of the present invention for use by infants and small children in accordance with the disclosed architecture;

FIG. 2 illustrates a perspective view of one potential embodiment of the first magnetic flange of the magnetic pacifier of the present invention in accordance with the disclosed architecture, wherein the first magnetic flange comprises both a magnetic ring and a gripping ring;

FIG. 3 illustrates a perspective view of one potential embodiment of the second magnetic flange of the magnetic pacifier of the present invention in accordance with the disclosed architecture, wherein the second magnetic flange comprises both a magnetic ring and a nipple for sucking;

FIG. 4 illustrates a perspective view of one potential embodiment of a magnetic pacifier of the present invention for use by infants and small children in accordance with the disclosed architecture, wherein a face mask is positioned between the two magnetically attracted flanges;

FIG. 5 illustrates a side perspective view of one potential embodiment of a magnetic pacifier of the present invention being used by an infant in accordance with the disclosed architecture, wherein the face mask is positioned between the two magnetically attracted flanges and attached to the infant's face;

FIG. 6 illustrates a diagrammatic representation of one potential embodiment of the essential components of the magnetic pacifier of the present invention in accordance with the disclosed architecture;

FIG. 7 illustrates a front perspective view of one potential embodiment of a magnetic pacifier of the present invention being used by a child in accordance with the disclosed architecture, wherein the face mask is positioned between the two magnetically attracted flanges and attached to the child's face; and

FIG. 8 illustrates a perspective view of one potential embodiment of a magnetic pacifier of the present invention attached to an article in accordance with the disclosed architecture and ready for use.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a pacifier device for an infant or small child that allows the infant/child to utilize the pacifier while the infant/child is wearing a face mask and without compromising the effectiveness of the face mask. More specifically, there is a long felt need in the art for a pacifier device which allows the face mask to be properly secured against the infant/child's face while the infant is using the pacifier, and that can easily be used with different types of protective face masks. Additionally, there is a long felt need in the art for a pacifier device that can be attached to the infant/child's clothing to prevent the same from becoming dirty or contaminated, and that comprises a tracking device that allows the pacifier and the infant to be quickly located.

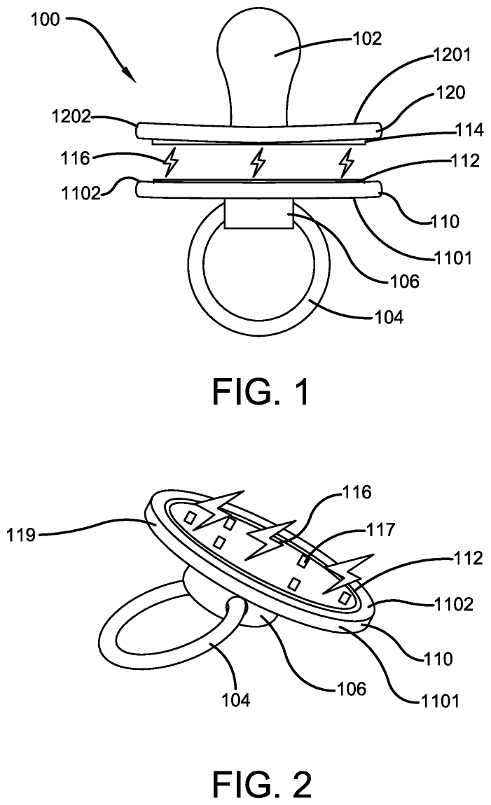

Referring initially to the drawings, FIG. 1 illustrates a perspective view of one potential embodiment of a magnetic pacifier 100 of the present invention for use by infants and small children in accordance with the disclosed architecture. More specifically, the magnetic pacifier 100 is comprised of a first magnetic flange 110 and a second magnetic flange 120. The first magnetic flange 110 has two opposing surfaces, namely a first surface 1101 having a handle, ring or other grasping element 104 to enable the infant or a parent or caregiver to securely grasp the pacifier 100 which is connected by a connecting member 106, and a second surface 1102 having a first magnetic ring 112. The first magnetic ring 112 can be in the form of a continuous strip of a magnetic material, or can have discrete magnets disposed around the surface. The second magnetic flange 120 also has two surfaces, wherein the first surface 1201 of the second flange 120 has a silicone nipple 102 or any similar sucking or pacifying means for a child thereon, and the second surface 1202 has an embedded second magnetic material 114. The second magnetic material 114 has a polarity that is the opposite of the polarity of the first magnetic ring 112, such that the two magnetic materials are attracted to one another. It should also be noted that the shape and configuration of the first magnetic ring 112 and the second magnetic ring 114 are preferably the same so that the two removably attach to one another when they are placed in close proximity to one another. Also, the magnetic power of the two magnetic rings 112, 114 is such that the magnetic rings are attached even when a cloth, paper or other breathable material, such as a face mask or face covering, is present between the two magnetic rings 112, 114, as described more fully below.

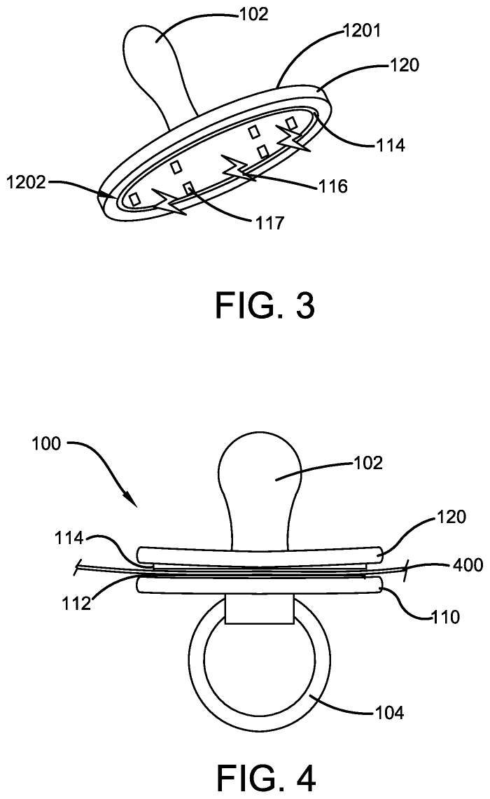

Each of the first and second magnetic flanges 110, 120 also act as a shield, and are preferably comprised of a silicone, flexible plastic, neoprene or rubber. Each of the magnetic rings 112, 114 are preferably embedded in their respective flanges 110, 120, but may also be removable so as to allow for cleaning of the pacifier in, for example, a dishwasher. The nipple 102 itself is preferably comprised of a food grade silicone, latex, or other suitable material and is in a shape that is comfortable for an infant or young child to suckle. The second flange 120 rests on the area around the outside of the mouth of the child while the pacifier 100 is being used by a child or infant, and the first flange 110 attaches to the second flange 120 via the magnetic rings 112, 114 when they are placed in close proximity to one another, albeit with a face mask positioned therebetween. More specifically, when the magnetic rings 112, 114 are placed in close proximity to one another, the magnetic field 116 between the magnets attracts the magnetic rings 112, 114 to each other and thus are removably attached. Each of the pacifier flanges 110 and 120 are provided with a series of openings 117 (see e.g., FIGS. 2 and 3) to allow for air transmission and to avoid the risk of suffocation of the child. Further, the magnetic rings 112, 114 are preferably not detachable from the flanges 110, 120 even when the nipple 102 is detached from the second flange 120 by applying a small force, or due to sucking by the child, so as to avoid a choking hazard. Further, the magnetic rings 112, 114 can be used to attach the pacifier device 100 around clothing, a blanket, backpack or the like to prevent the magnetic pacifier 100 from being dropped or lost when not in use. Also, each of the flanges 110, 120 and magnetic portions have a substantially circular shape, but are not required to and other shapes and configurations are also contemplated. For example, the flanges 110, 120 can have a semi-circular shape and can curve inwardly toward the front side of the magnetic pacifier 100 to better conform to the face of the infant.

FIG. 2 illustrates a perspective view of one potential embodiment of the first magnetic flange 110 of the magnetic pacifier 100 of the present invention in accordance with the disclosed architecture, wherein the first magnetic flange 110 comprises both a magnetic ring 112 and a gripping ring 104. More specifically, the magnetic ring 112 is circumferentially disposed around a perimeter or outer edge 119 of the flange 110, and the gripping ring, handle or other grasping element 104 is used for holding, removing and/or securing the pacifier 100 in place. As shown, the first magnetic flange 110 has a magnetic surface 1102, also referred to as the second surface, which contains an embedded magnet in the form of the magnetic ring 112 which produces a magnetic field 116 to attract another magnet, namely the second magnetic ring 114. The first magnetic flange 110 also comprises a non-magnetic surface 1101, also sometimes referred to herein as the first surface, which has an attached movable ring, handle or other grasping element 104 connected to the first surface 1101 via a connector 106. The connecting member 106 is embedded in, or integrally formed with, the first surface 1101, and the ring 104 is removably attached to the connecting member 106.

The magnetic ring 112 is a relatively thin, lightweight but strong magnet which adds to the aesthetic appeal of the magnetic pacifier 100. The magnetic surface 1102 is also preferably smooth and does not have any protrusions or ridges that would lessen the magnetic connection. By way of background, magnets are generally divided into two categories, namely permanent magnets and soft magnets. Permanent magnets are ferrite magnets and metal alloy magnets such as, but not limited to, neodymium iron boron, samarium cobalt and aluminum nickel cobalt. The magnetic rings 112, 114 of the present invention are preferably comprised of a magnetic material having a grade of N42 and a Br (residual flux density) of 13,200 Gauss. The magnets are preferably Neodymium magnets, which are composed of a rare earth-based material and referred to as NdFeB as they are composed mostly of Neodymium (Nd), Iron (Fe) and Boron (B). Neodymium magnets are recognized as some of the strongest magnets in the world.

FIG. 3 illustrates a perspective view of one potential embodiment of the second magnetic flange 120 of the magnetic pacifier 100 of the present invention in accordance with the disclosed architecture, wherein the second magnetic flange 120 comprises both a magnetic ring 114 and a nipple 102. The second magnetic flange 120 has a non-magnetic surface 1201 (also referred to as a first surface) having an attached nipple 102. The second magnetic flange 120 also has a magnetic surface 1202 (also referred to as a second surface) which contains an embedded magnet in the form of a magnetic ring 114 that produces a magnetic field 116 to attach to another magnet, namely the magnetic ring 112 of the first flange 110. The nipple 102 can be removed and replaced with a new nipple if required, or interchanged with other suitable shapes or elements. Furthermore, the nipple 102 may be made of a transparent or translucent, non-toxic, hypo-allergenic material that can safely be introduced into an infant's mouth. The nipple 102 may also have any known and/or convenient shape, size or configuration.

FIG. 4 illustrates a perspective view of one potential embodiment of a magnetic pacifier 100 of the present invention for use by infants and small children in accordance with the disclosed architecture, wherein a face mask 400 is positioned between the two magnetically attracted flanges 110, 120. More specifically, each of the two flanges 110, 120 are placed on a respective side of the face mask 400 with the magnetic rings 112, 114 touching or contacting the face mask 400 from opposite sides such that the magnetic rings 112, 114 are attached to each other and thus attach the flanges 110, 120 to each other. In this manner, an infant or a child may wear the face mask 400 while also utilizing the magnetic pacifier 100, and the presence of the pacifier 100 does not reduce the effectiveness of the face mask 400. Additionally, similar to its attachment to the face mask 400, the pacifier 100 can also be attached in a similar manner to other articles, such as a shirt, baby blanket, car seat strap, etc. to ensure that the pacifier stays clean and is readily accessible.

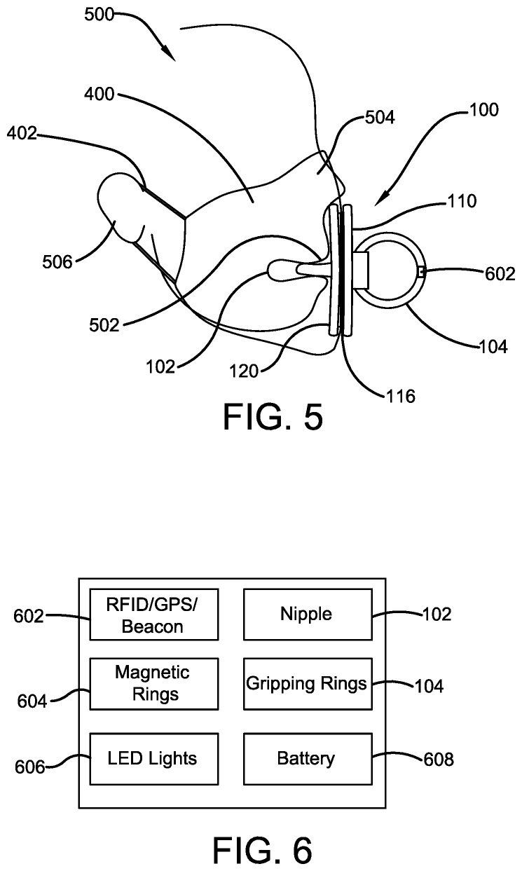

FIG. 5 illustrates a side perspective view of one potential embodiment of a magnetic pacifier 100 of the present invention being used by an infant 500 in accordance with the disclosed architecture, wherein the face mask 400 is positioned between the two magnetically attracted flanges 110, 120 and attached to the infant's face. As shown, the child 500 may suck on the pacifier nipple 102 when disposed in the child's mouth 502 with the second flange 120 acting as a shield. Over the second flange 120, the child 500 wears the face mask or other face covering 400, which may have ear loops 402 disposed over the child's ears 506 such that the face mask 400 substantially covers the mouth and nose 504 of the child 500. In this manner, the child 500 is able to use the pacifier nipple 102 to reduce anxiety, maintain comfort and be soothed, while also maintaining protection from pathogens by wearing the face mask or face covering 400. The first flange 110 is positioned on the exterior surface of the face mask 400 and is removably attached to the first flange 110 by the magnetic field 116 created by the magnetic rings 112, 114.

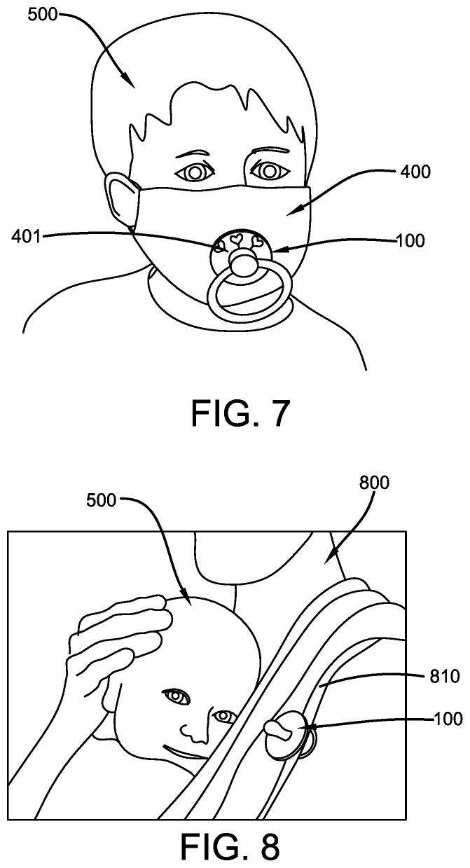

It should be appreciated that the appearance, size, weight and feel of the magnetic pacifier 100 of the present invention is similar to that of a conventional pacifier and it is very easy and safe to use for an infant, toddler or child. To remove the pacifier 100 from the face mask 400, the first flange 110 can be pulled in a direction that is opposite to the second flange 120 so as to break the magnetic field or forces 116, and then the face mask 400 can be removed to take the nipple 102 out of the child's mouth 502. In one potential embodiment, the magnetic pacifier 100 is commercially available with corresponding face masks 400 of various sizes. Nipples 102 of various colors can also be packaged and correspond to the color of the face mask 400. The flanges 110, 120 may also be provided in different colors and have indicia 401 (see e.g., FIG. 7) disposed thereon.

FIG. 6 illustrates a diagrammatic representation of one potential embodiment of the essential components of the magnetic pacifier 100 of the present invention in accordance with the disclosed architecture. More specifically, the pacifier 100 has magnetic rings 604 which are embedded into the two individual flanges of the pacifier 100. Similar to conventional pacifiers, a nipple 102 for sucking and a gripping ring or handle 104 are present on separate flanges for an efficient functioning of the magnetic pacifier 100. A special feature of the magnetic pacifier 100 of the present invention is the presence of a location tracking chip 602, which can be in the form of a GPS transmitter, and active or passive RFID tag, NFC, or a beacon to track the location of the magnetic pacifier 100 which can be used for tracking the child who is using the pacifier 100 or to find the pacifier 100 if it is lost. More specifically, the magnetic pacifier 100 can be paired with a smartphone of a parent or guardian and will track in real time the location information of the pacifier 100. The smart device can also be programmed to provide a notification to the user once the magnetic pacifier 100 crosses a user defined perimeter from the parent or guardian such as, but not limited to, 20 meters, 30 meters, etc. The tracking chip 602 is preferably a relatively small and inconspicuous chip that is embedded in one of the flanges 110, 120 or in the handle 104 so as to lessen any magnetic interference from the magnetic material (see e.g., FIG. 4). The chip 602 is useful for maintaining the safety of the child 500, as the child 500 who is using the pacifier 100 can then be tracked using the location of the pacifier 100 in the event that the child is lost or kidnapped. A notification can also be sent to multiple smartphones as well, which can be paired with the magnetic pacifier 100 by scanning/reading a QR code/Barcode/RFID/NFC code on the magnetic pacifier 100.

In yet a further embodiment of the present invention, the magnetic pacifier 100 may further comprise one or more LED lights 606 positioned therealong for illumination, entertainment or novelty purposes. The LED lights 606 may be powered using solar energy or disposable or rechargeable batteries 608. Further, the LED lights 606 may display different colors depending upon the proximity of the pacifier 100 from the paired electronic device of the parent or guardian. For example, the LED lights 606 may emit a green color when the paired smartphone is very near (e.g., up to a distance of 10 meters) the magnetic pacifier 100, and can change to yellow if the distance between the paired smartphone and the magnetic pacifier 100 is between, for example, 11 and 40 meters. Similarly, the color can change to red if the distance increases beyond 40 meters. Nonetheless, it will be appreciated that the forgoing colors and associated distances are but one example of the benefits of such an identification system and are not meant as a limitation.

FIG. 7 illustrates a front perspective view of one potential embodiment of a magnetic pacifier 100 of the present invention being used by a child 500 in accordance with the disclosed architecture, wherein the face mask 400 is positioned between the two magnetically attracted flanges 10, 120 and attached to the child's face. As shown, the child 500 may simultaneously wear a cloth, paper, or other material face mask or face covering 400 for protection against pathogens and the like, while still being able to enjoy the comforts of the pacifier 100. More specifically, the magnetic rings 112, 114 of the flanges 110, 120 are removably attached to each other with the face mask or face covering 400 positioned therebetween.

FIG. 8 illustrates a perspective view of one potential embodiment of a magnetic pacifier 100 of the present invention attached to an article in accordance with the disclosed architecture. More specifically, the pacifier 100 may be attached to an article of clothing or the strap 810 of a backpack of a user 800, as shown in FIG. 8. It should be appreciated that the magnetic pacifier 100 is not only extremely helpful for toddlers and other children wearing a face mask, but the magnetic pacifier 100 is also great to stick on the child's clothing, the parent's clothing, etc. for easy access to the pacifier 100 when needed. The magnetic strength of the pacifier 100 is such that the flanges 110, 120 are easily connected to each other even if a cloth, backpack, face mask or face covering is present between the flanges.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “magnetic pacifier for infants”, “pacifier device for infants”, “infant pacifier”, and “pacifier” are interchangeable and refer to the magnetic pacifier 100 of the present invention.

Notwithstanding the forgoing, the magnetic pacifier 100 of the present invention and its various components can be of any suitable size and configuration as is known in the art without affecting the overall concept of the invention, provided that they accomplish the above stated objectives. One of ordinary skill in the art will appreciate that the size, configuration and material of the magnetic pacifier 100 and its components as shown in the various FIGS. are for illustrative purposes only, and that many other sizes and shapes of the magnetic pacifier 100 are well within the scope of the present disclosure. Although the dimensions of the magnetic pacifier 100 and its components are important design parameters for user convenience, the magnetic pacifier 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pacifier comprising:
a first flange;
a second flange;
a first magnetic material disposed on the first flange;
a second magnetic material disposed on the second flange, wherein the second magnetic material has a polarity that is opposite that of the first magnetic material;
a grasping element connected to the first flange; and
a nipple connected to the second flange, wherein the first and second flanges are held together by the first and second magnetic materials.

2. The pacifier as recited in claim 1 further comprising a breathable material positioned between the first and second flanges.

3. The pacifier as recited in claim 1 further comprising a connecting member positioned between the grasping element and the first flange.

4. The pacifier as recited in claim 1, wherein the first magnetic material is disposed near a first perimeter of the first flange and the second magnetic material is disposed near a second perimeter of the second flange.

5. The pacifier as recited in claim 4, wherein the first magnetic material is provided as one of a continuous band extending around the first perimeter or a plurality of discrete elements.

6. The pacifier as recited in claim 1, wherein each of the first and second magnetic materials is selected from one of a metal alloy or a ferrite material.

7. The pacifier as recited in claim 6, wherein the metal alloy is selected from a group comprising a neodymium iron boron, a samarium cobalt and an aluminum nickel cobalt.

8. The pacifier as recited in claim 6, wherein the metal alloy is neodymium iron boron.

9. The pacifier as recited in claim 1, wherein each of the first and second magnetic materials has a grade of N42 and a residual flux density of approximately 13,200 Gauss.

10. The pacifier as recited in claim 1, wherein at least one of the first and second flanges is provided with an opening for air transmission.

11. The pacifier as recited in claim 1 further comprising a locating device.

12. The pacifier as recited in claim 11, wherein the locating device is one of a beacon, an RFID tag, a GPS chip, and a Bluetooth transmitter.

13. A pacifier and face covering combination comprising:
a pacifier comprised of a first flange having a first magnetic material extending circumferentially around a first perimeter, a second flange having a second magnetic material extending circumferentially around a second perimeter, a handle attached to the first flange and a nipple attached to the second flange; and
a face covering disposed between the first and second flanges.

14. The pacifier and face covering combination as recited in claim 13, wherein the first magnetic material has a polarity that is opposite that of the second magnetic material.

15. The pacifier and face covering combination as recited in claim 13, wherein each of the first and second magnetic materials is a samarium cobalt or an aluminum nickel cobalt.

16. The pacifier and face covering combination as recited in claim 13, wherein each of the first and second flanges are comprised of a silicone, a flexible plastic, a neoprene or a rubber.

17. The pacifier and face covering combination as recited in claim 13 further comprising a tracking chip.

18. The pacifier and face covering combination as recited in claim 13, wherein each of the first and second magnetic material is a neodymium iron boron.

19. An infant pacifier comprising;
a first flexible flange having a first surface, a second surfaces, a handle attached to the first surface, and a first magnetic material disposed in the second surface;
a second flexible flange having a first side, a second side, a nipple attached to the first side and a second magnetic material disposed in the second side; and
a tracking device attached to either the first flexible flange or the second flexible flange.

20. The infant pacifier as recited in claim 19, wherein at least one of the first and second flexible flanges has at least one opening for air egress.
